(19) United States
(12) Patent Application Publication
(10) Pub. No.: US 2003/0068507 A1
(43) Pub. Date: Apr. 10, 2003

(54) Process for producing a multi-layer film and multi-layer film produced according to that process

(76) Inventors: Conrad Henkens, Windischeschenbach (DE); Karl Pollmann, Erbendorf (DE)

Correspondence Address: BROWDY AND NEIMARK, P.L.L.C., 624 NINTH STREET, NW, SUITE 300, WASHINGTON, DC, 20001-5303, US

(21) Appl. No.: 10/085,021

(22) Filed: Mar. 1, 2002

(30) Foreign Application Priority Data
Oct. 9, 2001 (EP) 01124007.4

(51) Int. Cl. B32B 15/08

(52) U.S. Cl. 428/458; 428/472.2; 428/474.4

(57) ABSTRACT

A process for producing a multi-layer film, especially for food packaging, wherein at least one of the films is a plastic film and the laminating agent is chemically and/or physically derived from the plastic of that film, wherein a solution or dispersion of the plastic is applied as a laminating agent onto the first film, particularly an aluminum foil, the liquid of the solution or dispersion is completely vaporized and the first film is then joined in a laminating station to the second film at an increased temperature and under applied pressure.

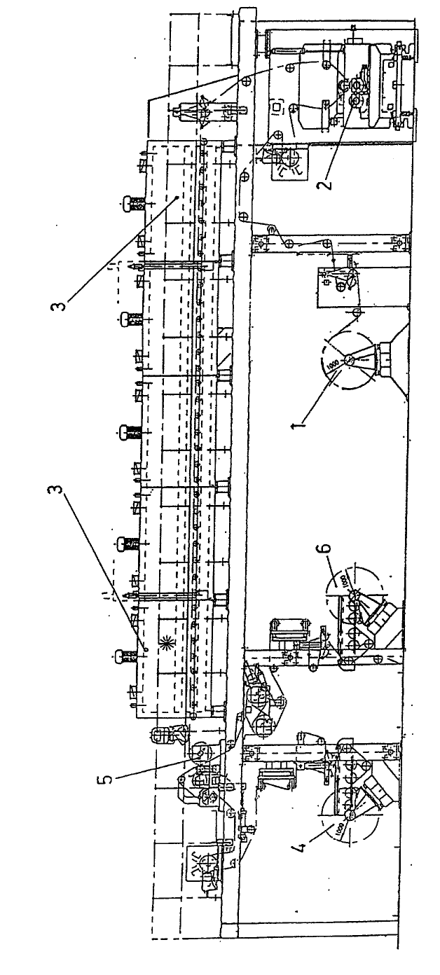

### BACKGROUND OF THE INVENTION

1. Field of the Invention

The invention is directed to a process for producing a multi-layer film, especially for food packaging, wherein at least one of the films of the film composite is a plastic film and the laminating agent is chemically and/or physically derived from the plastic of that film.

2. Background Art

Films of this type are known per se from DE 197 21 731 C1, DE 31 08 895 A1, CADA, Oldrich et. al.: Über die Verklebung von hydroisolierenden PVC Folien in: Adhäsion 1980, vol. 1, page 14 through 18, as well as LUCKE, H.: Kunststoffe und ihre Verklebung, Verlag Brunke Garrels, Hamburg, Germany, June 1967, page 103 through 105.

Multi-layer films are used on a large scale in the packaging industry, wherein, e.g., the utilized aluminum foil is impermeable to light, steam and flavors, so that films of this type can be used especially to package medicines and food items.

When containers are manufactured from multi-layer films of this type, the side of the composite that later forms the inside of the container is laminated with a usually thermoplastic plastic, primarily with polyurethanetype adhesives used as the laminating agents. If they are not used properly, primary aromatic amines can develop and subsequently leach into the contents of the container.

To prevent the use of such polyurethane-based laminating adhesives, extrusion laminates are known, which, however, have the shortcoming that they are complex, suitable only for large batches, expensive, and not applicable for certain types of plastics.

These problems are prevented with multi-layer films of the above type wherein an agent is used as the laminating agent that is chemically and/or physically derived from the plastic that will be laminated on, i.e., in other words, a laminating agent that is homologous to the plastic that will be laminated on.

### SUMMARY OF THE INVENTION

With this as the starting point, the invention has as its object to present a process that permits the production of high-quality multi-layer films of this type in an economical fashion.

This object is met in such a way that a solution or dispersion of the plastic is applied as a laminating agent to the first film, particularly an aluminum foil, the liquid of the solution or dispersion is completely vaporized, and the first film is then joined to the second film in a laminating station at an increased temperature and under applied pressure.

A significant advantage of this process, as a rule, lies in the fact that reactive components and reaction storage times are eliminated.

Optionally, and in dependence upon the given specific system, a triggering chemical may be added to the laminating agent, which, however, in any case has and may have a chemical composition such that it does not contain any migrating components that could pose a health hazard.

Provision may be made within the framework of the invention for further layers to be applied, e.g., a duroplastic layer, which, in containers made from the multi-layer film, then forms the outside and may preferably consist of polyamide or polyester.

The lamination of that film, too, takes place with an inventive laminating agent, i.e., a polyamide film is applied by means of a polyamide solution, and a polyester film by means of a polyester solution. To produce the PVC solution, ethylacetate, for example, may be used as a solvent. A polypropylene film is thus applied, for example, with a polypropylene dispersion. To laminate on a polyethylene film, a PE EVA dispersion may be used, also with all components being non-migrating.

The lamination is performed preferably at an increased temperature of 100° to 210° C. and with an increased laminating pressure of 25N/cm to 40 N/cm.

To sum it up, it can be said that a chemical-resistant, sterilizable multi-layer film is created according to the invention that can be produced in small batches and permits the production of sealable containers with or without the use of an outer laminated-on film of duroplastic plastic.

As compared to known films of this type, films that are produced according to the invention and containers that are produced from them are characterized by the following properties:

significantly improved resistance to chemicals;

noticeably improved bond strength;

markedly increased ductility.

The invention will be described in more detail below based on a preferred embodiment in conjunction with the drawing.

### BRIEF DESCRIPTION OF THE DRAWING

The drawing shows a schematic rendering of a laminating station that is known per se.

### DESCRIPTION OF THE PREFERRED EMBODIMENT

Produced is a composite of a 60 μm PVC film with a 20 μm aluminum foil, wherein a PVC copolymer of a 20% solution of the PVC copolymer in ethylacetate is used as the laminating agent.

In the process, the aluminum foil is unwound from a first dispensing station 1 and coated in an application installation 2 with the PVC copolymer, which is dried in a drying channel 3.

From a second dispensing station 4, PVC film is unwound, and in a laminating station 5 the aluminum foil and PVC film are joined at a temperature between 120° C. and 180° C. under pressure. The multi-layer film that was produced in this manner is rolled up in a winding station 6.

What is claimed is:

1. A process for producing a multi-layer film, especially for food packaging, with at least one of the films being a plastic film and the laminating agent being chemically and physically derived from the plastic of that film, wherein a solution or dispersion of the plastic is applied as a laminating agent onto the first film, particularly an aluminum foil, wherein the liquid of the solution or dispersion is completely vaporized, and wherein the first film is then joined in a laminating station to the second film at an increased temperature and under applied pressure.

2. A process according to claim 1, wherein the laminating agent comprises non-migrating trigger chemicals.

3. A process according to claim 1, wherein a further, especially duroplastic, layer is laminated onto the other side of the carrier film.

4. A process according to claim 3, wherein the further, thermoplastic layer is composed of polyamide or polyester.

5. A process according to claim 1, wherein the laminating temperature is between 100° C. and 210° C.

6. A process according to claim 1, wherein the laminating pressure is 25 N/cm to 40 N/cm.

7. A multi-layer film produced according to a process of claim 1.

8. A multi-layer film according to claim 7, wherein it comprises a polyamide film, an aluminum foil and a polypropylene film with a polypropylene dispersion as the laminating agent.

9. A container produced from a multi-layer film according to claim 7.
